(19) United States
(12) Patent Application Publication
(10) Pub. No.: US 2003/0059712 A1
(43) Pub. Date: Mar. 27, 2003

(54) Optical information recording medium and method of producing the same

(76) Inventor: Tohru Yashiro, Kanagawa (JP)

Correspondence Address: COOPER & DUNHAN LLP, 1185 Ave. of the Americas, New York, NY, 10036, US

(21) Appl. No.: 10/293,185

(22) Filed: Nov. 13, 2002

Related U.S. Application Data
(63) Continuation of application No. 09/709,811, filed on Nov. 10, 2000, now abandoned.

(30) Foreign Application Priority Data
Nov. 12, 1999 (JP) 11-323281

(51) Int. Cl. G11B 7/24

(52) U.S. Cl. 430/270.16; 430/945; 428/64.8; 369/275.4; 369/284

(57) ABSTRACT

An optical information recording medium includes a substrate with a wobble groove and/or pits being formed on one surface thereof, a colorant recording layer provided on the surface of the substrate, and a metallic reflection layer provided on the colorant recording layer, wherein the wobble groove has a track pitch in a range of 1.5 μm to 1.7 μm, and a half-amplitude level thereof in a range of 0.4 μm to 0.75 μm, and the colorant recording layer includes a specific phthalocyanine compound represented by formula (I) as defined in the specification, and a method of producing the optical information recording medium is proposed.

### BACKGROUND OF THE INVENTION

1. Field of the Invention

The present invention relates to an optical information recording medium, which can be utilized as high speed CD-R and CD-RW, and a method of producing the same.

2. Discussion of Background

Recently, in addition to write once read many type CDs (compact disks), recordable CDs, such as CD-R, CD-RW, have been used in practice. These CDs, unlike conventional CDs, have a feature that user's information can be recorded and recorded information can be reproduced by commercially available CD players, since these CDs can meet the standards of the conventional CDs.

A method of producing such a medium as mentioned above, for instance, CD-R, is proposed in Japanese Laid-Open Patent Application 2-42652, in which a dye is spin-coated on a substrate to form a light absorption layer, and then a metallic light reflection layer is provided behind the light absorption layer.

Cyanine dye materials have been mainly used as materials for the light absorption layer. Such cyanine dye materials have excellent optical characteristics since they have a large light absorption coefficient, but have a shortcoming as well that the light resistance thereof is poor.

Under such circumstances, it has been proposed to use phthalocyanine dyes with excellent light resistance, for instance, as disclosed in Japanese Laid-Open Patent Application 3-62878.

With respect to a derive for recording, drives with higher recording speeds than the conventional 1×nominal speed (about 1.3 m/s) have been commercialized, and are now popular among general users due to the processing speed. Currently, a quadruple (4×) recording speed (about 5.2 m/s) model is most popular, but drives with 6× and 8×recording speeds are also on the market. However, when recording is conducted at recording speeds as high as the quadruple recording speed or at higher recording speeds, using the conventional CD-R media, the quality of signals is inferior to that obtained at the 1×nominal speed. In other words, when recording and reproduction are carried out at such high speeds, a margin for recording power is small and there are lowered the reproduction characteristics for the address information recorded in the wobble groove. Furthermore, in some combination of recording apparatus and reproducing apparatus, there is the risk that reproduction errors are caused.

### SUMMARY OF THE INVENTION

It is therefore a first object of the present invention to provide an optical information recording medium, with high operational reliability and high durability under high speed recording conditions, free of the above-mentioned conventional problems.

A second object of the present invention is to provide a method of producing the above-mentioned optical information recording medium.

The first object of the present invention can be achieved by an optical information recording medium comprising:

a substrate with a wobble groove and/or pits being formed on one surface thereof,

a colorant recording layer provided on the surface of the substrate, and

a metallic reflection layer provided on the colorant recording layer, wherein the wobble groove has a track pitch in a range of 1.5 μm to 1.7 μm, and a half amplitude level in a range of 0.4 μm to 0.75 μm, and the colorant recording layer comprises a phthalocyanine compound represented by formula (I):

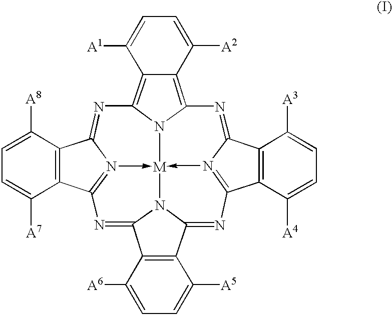

wherein M is a center metal which is selected from the group consisting of a divalent metal atom, a mono-substituted trivalent metal atom, a di-substituted tetravalent metal or an oxy metal; and one of A¹ or A², one of A³ or A⁴, one of A⁵ or A⁶, and one of A⁷ or A⁸ are each independently —O—C(R¹)(R³)—R², and the other in each pair is a hydrogen atom, in which R¹ and R³ are each independently an alkyl group, a fluorine-substituted alkyl group, or a hydrogen atom, and R² is an alkyl group, an unsubstituted or substituted phenyl group.

In the above optical information recording medium of the present invention, it is preferable that the center metal represented by M in the phthalocyanine compound be one metal atom or a metal oxide selected from the group consisting of Zn, Ni, Cu, Pd, VO, and TiO, and R¹ and R³ be each independently —CF₃. In this optical information recording medium, particularly good recording and reproduction characteristics and durability can be attained at-high speed recordings.

The second object of the present invention can be achieved by a method of producing the optical information recording medium comprising the steps of:

providing a light absorption layer, directly or via an intermediate layer, on a substrate with a wobble groove and/or pits being formed on the surface thereof, using film formation coating means, the light absorption layer comprising as a main component the above-mentioned phthalocyanine compound represented by formula (I),

providing a light reflection layer, directly or via an intermediate layer, on the light absorption layer by vacuum film formation means, and

providing a protective layer on the light reflection layer.

By this method, the above-mentioned optical information recording medium can be easily produced.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram showing the jitter margin for the recording power margin (β) for each of Example 1 and Comparative Example.

FIG. 2 is a diagram showing the ATIP signal jitter after demodulation in Example 3.

### DESCRIPTION OF THE PREFERRED EMBODIMENTS

In the present invention, by use of the phthalo-cyanine compound represented by the above formula (I) in the colorant recording layer, and by setting the track pitch of the wobble groove in the range of 1.5 μm to 1.7 μm, and the half-amplitude level thereof in the range of 0.4 μm to 0.75 μm, the margin for the recording power at high speed recording can be increased and the reproduction characteristics of the address information recorded in the wobble groove can be improved.

This is because the above-mentioned center metals serve to improve the complex index of refraction of the recording layer which works as a light absorption layer, and make it easy to obtain high reflectivity.

Specific preferable examples of M for the compound of formula (I) are as follows:

[Divalent metals]

Cu²⁺, Zn²⁺, Fe²⁺, Co²⁺, Ni²⁺, Ru²⁺, Rh²⁺, Pd²⁺, Pt²⁺, Mn²⁺, Mg²⁺, Ti²⁺, Be²⁺, Ca²⁺, Ba²⁺, Cd²⁺, Hg²⁺, Pb²⁺ and Sn²⁺.

[Mono-substituted Trivalent Metals]

Al—Cl, Al—Br, Al—F, Al—I, Ga—Cl, Ga—F, Ga—I, Ga—Br, In—Cl, In—Br, In—I, In—F, Tl—Cl, Tl—Br, Tl—I, Tl—F, Al—C₆H₅, Al—C₆H₄(CH₃), In—C₆H₅, In—C₆H₄(CH₃), In—C₁₀H₇, Mn(OH), Mn(OC₆H₅), Mn[OSi(CH₃)₃], FeCl and RuCl.

[Di-substituted Tetravalent Metals]

CrCl₂, SiCl₂, SiBr₂, SiF₂, SiI₂, ZrCl₂, GeCl₂, GeBr₂, GeI₂, GeF₂, SnCl₂, SnBr₂, SnI₂, SnF₂, TiCl₂, TiBr₂, TiF₂, Si(OH)₂, Ge(OH)₂, Zr(OH)₂, Mn(OH)₂, Sn(OH)₂, Ti(R¹⁰)₂, Cr(R¹⁰)₂, Si(R¹⁰)₂, Sn(R¹⁰)₂ and Ge(R¹⁰)₂ wherein R¹⁰ is an alkyl group, phenyl group, naphthyl group or a derivative of any of the aforementioned groups,

Si(OR¹¹)₂, Sn(OR¹¹)₂, Ge(OR¹¹)₂, Ti(OR¹¹)₂, and Cr(OR¹¹)₂ wherein R¹¹ is an alkyl group, phenyl group, naphthyl group, a trialkyl silyl group, a dialkyl alkoxy silyl group or a derivative of any of the aforementioned group, and Sn(SR¹²)₂ and Ge(SR¹²)₂ wherein R¹² is an alkyl group, phenyl group, naphthyl group, or a derivative of any of the aforementioned groups.

[Oxy Metals]

VO, MnO and TiO

Specific examples of R¹ and R³ are methyl group, ethyl group, propyl group, isopropyl group, n-propyl group, n-butyl group, sec-butyl group, tert-butyl group, —CF₃, —C₂F₅, —CF(CF₃)₂, and a hydrogen atom.

It is preferable that R¹ and R³ be both —CF₃, since by the presence of —CF₃, the thermal decomposition temperature of the phthalocyanine compound is lowered and accordingly the recording sensitivity of the optical information recording medium of the present invention is increased.

Specific examples of R² are phenyl group, naphthyl group, 2-methylphenyl group, 2,4-dimethylphenyl group, 2,4,6-trimethylphenyl group, 2-isopropylphenyl group, 2,5-dimethylphenyl group, 2,6-dimethylphenyl group and 2-ethylphenyl group.

It is preferable that the alkyl group bonded as a substituent to the above-mentioned phenyl group have 1 to 4 carbon atoms for obtaining appropriate light absorbency per unit thickness of the light absorption layer and therefore also for obtaining excellent complex index of refraction of the light absorption layer. In other words, when the number of carbon atoms of the alkyl exceeds 4, the light absorbency per unit thickness of the light absorption layer tends to be lowered and therefore the excellent complex index of refraction of the light absorption layer tends to become difficult to obtain.

The above-mentioned phthalocyanine compound of formula (I) can be easily synthesized by cyclization of a mixture of their respective corresponding phthalonitrile compounds. To be more specific, the following phthalonitrile of formula (II) is allowed to react with a metal derivative in alcohol, for instance, in the presence of 1,8-diazabicyclo[5,4,0]-7-undecene, with the application of heat thereto:

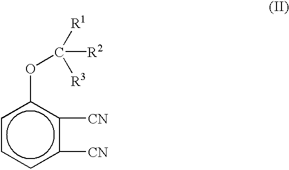

The light absorption layer comprising the above-mentioned phthalocyanine compound (I) can be provided without difficulty by dissolving the compound in a solvent to prepare a coating liquid and coating the coating liquid on a substrate.

In the case where the center metal M is Fe²⁺, Co²⁺, Zn²⁺, Cd²⁺ or Mn²⁺, it is preferable to add an amino compound. When the center metal M is any of the above-mentioned metals, the amino compound is easily coordinated with the center metal M, so that the solubility of the compound (I) in the solvent is increased by the above coordination and therefore the film formation property of the compound (I) is significantly improved.

As such an amino compound, amino compounds having heterocyclic rings with N atoms being included in the heterocyclic rings are preferable, since such compounds are capable of hindering the association of the phthalocyanine compounds and such compounds themselves have excellent heat resistance and light resistance.

Furthermore, it is preferable that the amino compounds for use in the present invention have a melting point of 150° C. or more in order to maintain the thermal stability of the light absorption layer and to prevent, in particular, the optical characteristics of the light absorption layer from being changed at high temperatures and high humidities. In view of the above, imidazole, benzimidazole and thiazole and derivatives thereof are particularly preferable for use in the present invention.

Examples of such amino compounds are as follows, but amino compounds for use in the present invention are not limited to the following:

n-butylamine, n-hexylamine, tert-butylamine, pyrrole, pyrrolidine, pyridine, piperidine, purine, imidazole, benzimidazole, 5,6-dimethylbenzimidazole, 2,5,6-trimethylbenzimidazole, naphthoimidiazole, 2-methyl-naphthoimidazole, quinoline, isoquinoline, quinoxaline, benzquinoline, phenanthridine, indoline, carbazole, norharman, thiazole,-benzthiazole, benzoxazole, benztriazole, 7-azaindole, tetrahydro-quinoline, triphenylimidazole, phthalimide, benzo-isoquinolin-5,10-dione, triazine, perimidine, 5-chlorotriazole, ethylene-diamine, azobenzene, trimethylamine, N,N-dimethylformamide, 1(2H)phthalazinone, phthalhydrazide, 1,3-diimino-isoindoline, oxazole, polyimidazole, polybenzimidazole, and polythiazole.

The wobble groove has a half-amplitude level in a range of 0.4 μm to 0.75 μm, at a track pitch in a range of 1.5 μm to 1.7 μm, which is used in conventional CDs. The half-amplitude level can be measured by an AFM diffraction apparatus. It is preferable that the measurement of the half-amplitude level be carried out by AMF. In the measurement of the half-amplitude level by diffraction, the effects of the depth of the groove on the measurement cannot be avoided and accordingly, the error in the measurement is large. When the half-amplitude level is larger than 0.75 μm, recording pits which are formed by laser beam application tend to spread in the direction of the width thereof, so that the margin for the recording power is narrowed. On the other hand, when the half-amplitude level is smaller than 0.4 μm, recording pits are difficult to be formed by laser beam application, so that suitable recording sensitivity and signal modification become difficult to obtain.

Thus, when the half-amplitude level is 0.75 μm or less under the above-mentioned conditions, the interference between the wobble of adjoining tracks, which may be referred to as cross-talk, can be prevented, so that the lowering of the quality of signals for the address information (ATIP, which stands for Absolute Time in Pre-groove) recorded in the wobble groove can be minimized and accordingly, the reproduction characteristics can be improved.

In the present invention, the depth of the wobble groove is in the range of 800 Å to 2000 Å, preferably in the range of 1200 Å to 1700 Å, in order to obtain appropriate track signal (PPA) and seek signal (RCb).

Any dyes used as recording materials in conventional information recording materials can also be added as light absorbing materials to the above-mentioned phthalocyanine compound (I).

Examples of such dyes are cyanine dyes, pyrylium.thiopyrylium dyes, azulenium dyes, squalilium dyes, metal complex dyes such as Ni, Cr complex dyes, naphthoquinone.anthraquinone dyes, indophenol dyes, indoaniline dyes, triphenylmethane dyes, triarylmethane dyes, aminium.diimmonium dyes and nitroso compounds.

Further, when necessary, a third component such as a binder, a stabilizer and others can also be added thereto.

It is preferable that the light absorption layer have a thickness of 100 Å to 5000 Å, more preferably a thickness of 500 Å to 3000 Å, in order to obtain appropriate recording sensitivity and reflectivity. This is because in terms of the above-mentioned ranges of the thickness of the light absorption layer, the thinner the light absorption layer, the lower the recording sensitivity, while the thicker the light absorption layer, the lower the reflectivity.

Any materials that are used as the material for the substrate of conventional optical information recording media can also be used as the material for the substrate of the optical information recording medium of the present invention.

Specific examples of the materials for the substrate for the optical recording medium of the present invention are acrylic resin such as polymethyl methacrylate; vinyl chloride resin such as polyvinyl chloride and vinyl chloride copolymer; epoxy resin; polycarbonate resin; amorphous polyolefin; polyester; glass such as soda glass; and ceramics. In particular, from the viewpoints of dimensional stability, transparency and flatness, as the materials for the substrate, polymethyl methacrylate, polycarbonate resin, epoxy resin, amorphous polyolefin, polyester and glass are preferable for use in the present invention.

In order to improve the flatness and adhesion of the surface of the substrate on the side for the light absorption layer to be provided, and also to prevent the deterioration of the surface of the substrate, an undercoat layer may be provided between the light absorption layer and the substrate.

Examples of the materials for the undercoat layer are polymers such as polymethyl methacrylate, acrylic acid/methacrylic acid copolymer, styrene/maleic anhydride copolymer, polyvinyl alcohol, N-methylol acrylic amide, styrene/sulfonic acid copolymer, styrene/vinyltoluene copolymer, chlorosulfonated polyethylene, nitrocellulose, polyvinyl chloride, chlorinated polyolefin, polyester, polyimide, vinyl acetate/vinyl chloride copolymer, ethylene/vinyl acetate copolymer, polyethylene, polypropylene and polycarbonate; organic materials such as silane coupling agents; and inorganic materials, for example, inorganic oxides such as SiO₂ and Al₂O₃, and inorganic fluorine compounds such as MgF₂.

It is preferable that the undercoat layer have a thickness in the range of 0.005 μm to 20 μm, more preferably in the range of 0.01 μm to 10 μm.

On the surface of the substrate or the undercoat layer, there may be provided a pre-groove layer in the form of concave or convex grooves for tracking or for indicating information such as address signals. As the material for the pre-groove layer, there can be employed a mixture of at least one monomer or oligomer selected from the group consisting of monoacrylate, diacrylate, triacrylate and tetraacrylate, and a photopolymerization initiator.

Furthermore, on the light absorption layer, there may be provided a reflection layer for improvement of the S/N ratio and the reflectivity of the optical information recording medium, and also for improvement of the recording sensitivity thereof.

As the material for the reflection layer, there is employed a light reflection material having high reflectivity to laser beams.

Specific examples of such light reflection materials are metals and semi-metals such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ca, In, Si, Ge, Te, Pb, Po, Sn and Si.

Of the above-mentioned light reflection materials, Au, Al and Ag are particularly preferable for use in the present invention. The above-mentioned materials can be used alone, in combination or in the form of alloys.

It is preferable that the light reflection layer have a thickness in the range of 100 Å to 3000 Å.

Furthermore, a protective layer may be provided on the light absorption layer or on the reflection layer in order to protect the light absorption layer or the reflection layer physically or chemically.

Such a protective layer may also be provided on the side of the substrate on which the light absorption layer is not provided in order to improve the scratch resistance and humidity resistance of the optical information recording medium of the present invention. As the materials for the protective layer, for example, inorganic materials such as SiO, SiO₂, MgF₂ and SnO₂, thermoplastic resin, thermosetting resin, and UV curing resin can be employed.

It is preferable that the protective layer have a thickness in the range of 500 Å to 50 μm.

A method of producing the optical information recording medium of the present invention will now be explained.

The method of producing the optical information recording medium comprising the steps of:

(a) providing a light absorption layer, directly or via an intermediate layer, on a substrate with a wobble groove and/or pits being formed on the surface thereof, using film formation coating means, the light absorption layer comprising as a main component the above-mentioned phthalocyanine compound represented by formula (I),

(b) providing a light reflection layer, directly or via an intermediate layer, on the light absorption layer by vacuum film formation means, and

(c) providing a protective layer on the light reflection layer.

[Provision of Light Absorption Layer]

In the method of producing the optical information recording medium of the present invention, the light absorption layer comprising as a main component the above-mentioned phthalocyanine compound represented by formula (I) is provided, directly or via an intermediate layer, on the substrate with a wobble groove and/or pits being formed on the surface thereof, using film formation coating means.

More specifically, the phthalocyanine compound (I) is dissolved in a solvent, whereby a light absorption layer formation liquid is prepared.

The thus prepared light absorption layer formation liquid is then coated on the substrate. As the solvent for preparing the light absorption layer formation liquid, conventional organic liquids such as alcohol, cellosolve, halogenated hydrocarbon, ketone and ether can be employed.

As the film formation coating method for providing the light absorption layer, the spin coating method is preferable because the thickness of the light absorption layer can be easily controlled by adjusting the concentration and the viscosity of the light absorption layer formation liquid, and also the drying temperature of the coated light absorption layer formation liquid.

As mentioned above, the undercoat layer may be provided on the side of the substrate on which the light absorption layer is to be provided in order to improve the flatness and adhesion of the substrate, and also to prevent the deterioration of the light absorption layer.

The undercoat layer can be provided by the steps of dissolving or dispersing the previously mentioned material for the undercoat layer in an appropriate solvent to prepare an undercoat layer formation liquid, and coating the thus prepared undercoat layer formation liquid on the surface of the substrate by a coating method such as spin coating, dip coating or extrusion coating.

[Provision of Light Reflection Layer]

In the present invention, the light reflection layer is provided, directly or via an intermediate layer, on the light absorption layer by vacuum film formation. More specifically, any of the previously mentioned materials for the light reflection layer can be deposited on the light absorption layer, for instance, by vacuum deposition, sputtering or ion plating.

[Provision of Protective Layer]

In the present invention, the protective layer is provided on the light reflection layer. More specifically, the previously mentioned inorganic and other materials for the protective layer are deposited on the light reflection layer, for instance, by vacuum film deposition or film coating. As the material for the protective layer, UV curing resin is preferable. A protective layer composed of UV curing resin can be formed, for instance, by the steps of coating UV curing resin on the light reflection layer by spin coating, and curing the coated UV curing resin with irradiation of ultraviolet rays.

Other features of this invention will become apparent in the course of the following description of exemplary embodiments, which are given for illustration of the invention and are not intended to be limiting thereof.

### EXAMPLE 1

There was formed by injection molding a poly-carbonate disk with a diameter of 120 mm and a thickness of 1.2 mm, with a wobble groove with a track pitch of 1.58 μm, a half-amplitude level of 0.68 μm, and a depth of about 1500 Å being formed on the surface thereof.

A light absorption layer formation liquid was prepared by dissolving a phthalocyanine compound with the above-mentioned formula (I), in which M is VO, R¹ is —CF₃, R² is phenyl, and R³ is —CF₃, in a mixed solvent of tetrahydrofuran, 2-methoxyethanol, and ethyl cyclohexane.

The thus prepared light absorption layer formation liquid was coated by spin coating on the above injection-molded polycarbonate disk substrate, whereby a light absorption layer with a thickness of about 1500 Å was formed on the substrate.

Au was deposited by sputtering with a thickness of about 1000 521 on the above light absorption layer, whereby a light reflection layer was provided on the light absorption layer.

A protective layer composed of UV curing resin, with a thickness of about 5 μm, was formed on the light reflection layer by the above-mentioned method, whereby an optical information recording medium No. 1 of the present invention was prepared.

In order to measure the signal characteristics of the optical information recording medium No. 1, recording was conducted thereon, using a commercially available optical disk recording and reproduction apparatus (Trademark “DDU-1000” made by Pulstec Industrial Co., Ltd.) under the conditions that NA was 0.5, wavelength was 790 nm, line velocity was 4.8 m/s, recorded signals were CD signals (EFM), and the recording strategy was (n-1)T.

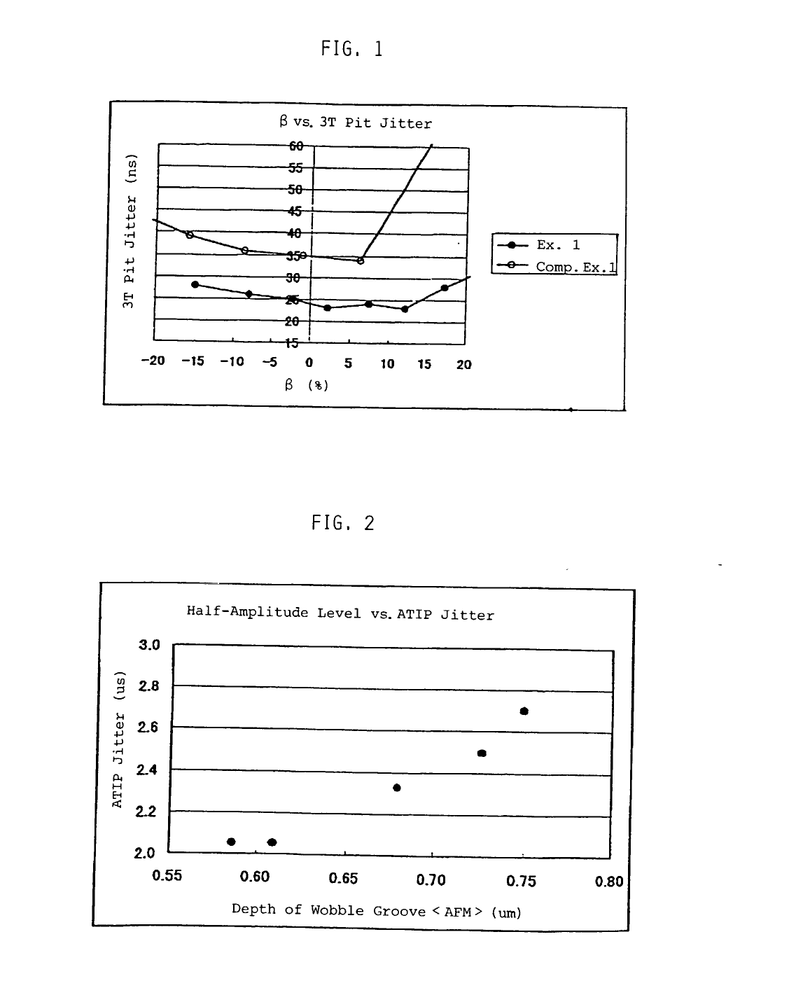

FIG. 1 shows the results of the measurement of 1×nominal speed reproduction 3T pit jitter, obtained by Jitter Meter (Trademark “LJM-1851” made by LEADER ELECTRONICS CORP.). The results indicate that there was observed an extremely low jitter characteristic, which was excellent, for a wide recording power range (β)

### EXAMPLE 2

The same procedure as in Example 1 was repeated except that the phthalocyanine compound employed in Example 1 was replaced by a phthalocyanine compound with the above-mentioned formula (I), in which M is TiO, R¹ is —CF₃, R² is 2-methyl phenyl, and R³ is —C₂F₅, whereby an optical information recording medium No. 2 of the present invention was prepared, and the jitter thereof was measured.

The results were as follows:

The values of Jitter:

β=−8%: 23 ns, β=+8%: 23 ns

The above results indicate that the results in Example 2 were as good as in Example 1.

### EXAMPLES 3-1, 3-2 and 3-3

The same procedure as in Example 1 was repeated except that the half-amplitude level of the polycarbonate disk substrate was changed to 0.58 μm, 0.61 μm, and 0.73 μm, whereby optical information recording media No. 3, No. 4, and No.5 of the present invention were prepared, and the minimum pit jitter of 4×speed reproduction ATIP signals after demodulation of each of these recording media was measured, using TIME INTERVAL ANALYZER (Trademark “5372A” made by HEWLETT PACKARD).

The results are as shown in FIG. 2, which indicate that excellent (low) jitter characteristics were obtained in the range of the half-amplitude level of 0.58 μm to 0.73 μm. Furthermore, the narrower the groove, the better the jitter.

### EXAMPLE 4

The same procedure as in Example 1 was repeated except that the half-amplitude level of the polycarbonate disk substrate was changed to 0.45 μm, whereby optical information recording medium No. 6 of the present invention were prepared, and the jitter thereof was measured.

The results were as follows:

The values of Jitter:

β=−8%: 21 ns, β=+8%: 22 ns

The above results indicate that the results in Example 4 were as good as in Example 1.

### Comparative Example

The same procedure as in Example 1 was repeated except that the phthalocyanine compound employed in Example 1 was replaced by a mixture of a cyanine dye with formula (III) and a cyanine dye with formula (IV), with a ratio of (III)/(IV)=1/2, which was dissolved in 2,2,3,3-tetrafluoropropanol, and that the half-amplitude level of the polycarbonate disk substrate was changed to 0.80 μm, whereby a comparative optical information recording medium was prepared, and the jitter thereof was measured.

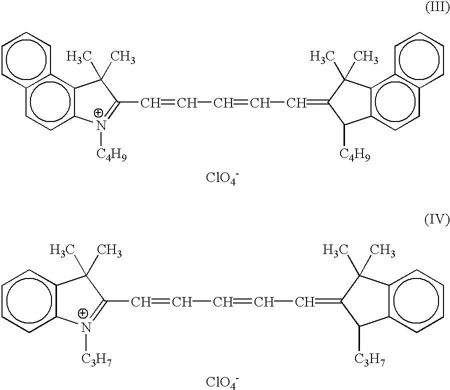

The results were as shown in FIG. 1, indicating that the thus prepared comparative optical information recording medium did not meet the CD standards (35 ns or less).

Japanese Patent Application No. 11-323281, filed Nov. 12, 1999, is hereby incorporated by reference.

What is claimed is:

1. An optical information recording medium comprising:
a substrate with a wobble groove and/or pits being formed on one surface thereof,
a colorant recording layer provided on the surface of said substrate, and
a metallic reflection layer provided on the colorant recording layer, wherein said wobble groove has a track pitch in a range of 1.5 μm to 1.7 μm, and a half-amplitude level thereof in a range of 0.4 μm to 0.75 μm, and said colorant recording layer comprises a phthalocyanine compound represented by formula (I): 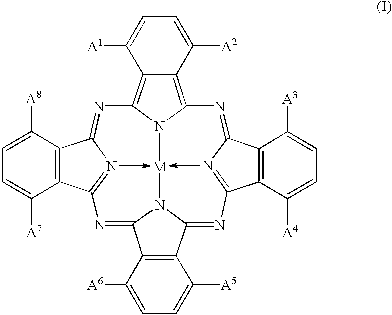
wherein M is a center metal which is selected from the group consisting of a divalent metal atom, a mono-substituted trivalent metal atom, a di-substituted tetravalent metal or an oxy metal; and one of A¹ or A², one of A³ or A⁴, one of A⁵ or A⁶, and one of A⁷ or A⁸ are each independently —O—C(R¹) (R³)—R², and the other in each pair is a hydrogen atom, in which R¹ and R³ are each independently an alkyl group, a fluorine-substituted alkyl group, or a hydrogen atom, and R² is an alkyl group, an unsubstituted or substituted phenyl group.

2. The optical information recording medium as claimed in claim 1, wherein said center metal represented by M in said phthalocyanine compound is one metal atom or a metal oxide selected from the group consisting of Zn, Ni, Cu, Pd, VO, and TiO, and R¹ and R³ are each independently —CF₃.

3. A method of producing an optical information recording medium comprising the steps of:
providing a light absorption layer, directly or via an intermediate layer, on a substrate with a wobble groove and/or pits being formed on the surface thereof, using film formation coating means, said light absorption layer comprising as a main component a phthalocyanine compound represented by formula (I): 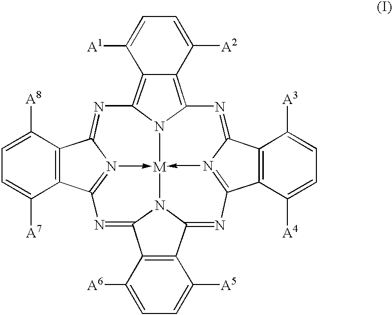
wherein M is a center metal which is selected from the group consisting of a divalent metal atom, a mono-substituted trivalent metal atom, a di-substituted tetravalent metal or an oxy metal; and one of A¹ or A², one of A³ or A⁴, one of A⁵ or A⁶, and one of A⁷ or A⁸ are each independently —O—C(R¹) (R³)—R², and the other in each pair is a hydrogen atom, in which R¹ and R³ are each independently an alkyl group, a fluorine-substituted alkyl group, or a hydrogen atom, and R² is an alkyl group, an unsubstituted or substituted phenyl group,
providing a light reflection layer, directly or via an intermediate layer, on the light absorption layer by vacuum film formation means, and
providing a protective layer on said light reflection layer.

4. The method as claimed in claim 3, wherein the center metal represented by M in the phthalocyanine compound is one metal atom or a metal oxide selected from the group consisting of Zn, Ni, Cu, Pd, VO, and TiO, and R¹ and R³ are each independently —CD₃.
